(19) United States
(12) Patent Application Publication
(10) Pub. No.: US 2017/0062801 A1
(43) Pub. Date: Mar. 2, 2017

(54) NON-AQUEOUS ELECTROLYTE SECONDARY BATTERY

(71) Applicant: Sanyo Electric Co., Ltd.

(72) Inventors: Yuu Takanashi, Hyogo (JP); Sho Tsuruta, Hyogo (JP); Atsushi Fukui, Hyogo (JP); Kazuhiro Hasegawa, Hyogo (JP)

(73) Assignees: Sanyo Electric Co., Ltd., Daito-shi, Osaka (JP); Sanyo Electric Co., Ltd., Daito-shi, Osaka (JP)

(21) Appl. No.: 15/106,771

(22) PCT Filed: Dec. 19, 2014
(86) PCT No.: PCT/JP2014/006340

§ 371 Date: Jun. 20, 2016

(30) Foreign Application Priority Data
Dec. 27, 2013 (JP) 2013-271277

(51) Int. Cl. H01M 4/131; H01M 10/0587; H01M 10/0569; H01M 10/0568; H01M 4/133; C01G 51/00; H01M 4/505; H01M 4/587; H01M 4/62; H01M 4/66; C01G 53/00; H01M 10/0525; H01M 4/525

(52) U.S. Cl. CPC H01M 4/131; H01M 10/0525; H01M 10/0587; H01M 10/0569; H01M 10/0568; H01M 4/133; H01M 4/525; H01M 4/505; H01M 4/587; H01M 4/623; H01M 4/625; H01M 4/661; C01G 53/50; C01G 53/42; C01G 51/50; H01M 2300/0034; H01M 2300/0037; H01M 2004/027

(57) ABSTRACT

A non-aqueous electrolyte secondary battery having a high capacity and a long life is provided by eliminating or reducing the structural change of a positive electrode active material at high voltages. The non-aqueous electrolyte secondary battery includes a positive electrode having a positive electrode active material that intercalates and deintercalates lithium ions, a negative electrode having a negative electrode active material that intercalates and deintercalates lithium ions, and a non-aqueous electrolyte. The positive electrode active material includes a lithium-cobalt composite oxide containing nickel, manganese, aluminum, and germanium. The percentage of cobalt in the lithium-cobalt composite oxide is 80 mol % or more with respect the total molar amount of metal elements except lithium.

### TECHNICAL FIELD

The present invention relates to a non-aqueous electrolyte secondary battery.

### BACKGROUND ART

Non-aqueous electrolyte secondary batteries, typified by lithium ion batteries, are often used as driving power sources of mobile phones, such as smart phones, and portable electronic devices, such as portable computers, PDAs, and portable music players. Furthermore, non-aqueous electrolyte secondary batteries are increasingly used as driving power sources of electric vehicles and hybrid electric vehicles, for controlling fluctuations in output power in photovoltaic power generation, wind power generation, and the like, and also in stationary battery systems for, for example, grid-power peak shifting in which electric power is stored at night and used during the daytime.

However, as devices including such secondary batteries improve, more power tends to be consumed, and there is a strong need for increased capacity. Measures to increase the capacity of such a non-aqueous electrolyte secondary battery include increasing the capacity of an active material, increasing the amount of an active material loaded per unit volume, and increasing the charge voltage of a battery. However, a high charge voltage of a battery tends to degrade the crystal structure of a positive electrode active material and to cause a reaction between the positive electrode active material and a non-aqueous electrolyte solution.

In PTL 1 described below, it has been reported that the cycle performance at a final voltage of 4.4 V is improved and the high-temperature storage performance at 4.2 V is improved by performing substitution in a positive electrode active material, which contains mainly lithium cobalt oxide, with nickel, manganese, and aluminum.

In PTL 2 described below, it has been reported that the cycle performance at 4.2 V is improved by covering the surface of a positive electrode active material with a compound to suppress a reaction between the active material and a non-aqueous electrolyte solution.

### CITATION LIST

### Patent Literature

PTL 1: Japanese Published Unexamined Patent Application No. 2007-265731

PTL 2: International Publication No. WO 2012/099265

### SUMMARY OF INVENTION

### Technical Problem

However, when a lithium-cobalt composite oxide is used in a positive electrode active material, and the charge voltage is increased such that the voltage of a positive electrode is higher than 4.5 V on a lithium basis, the crystal structure on the surface of the positive electrode active material and inside the positive electrode active material is phase-transferred from the O3 structure to the H1-3 structure. At the same time, the reaction between the positive electrode active material and an electrolyte solution becomes active on the surface, so that decomposition of the electrolyte solution proceeds. This results in degraded cycle performance. None of the PTLs described above has disclosed the phase transition that has occurred in a positive electrode active material or the reaction between the positive electrode active material and an electrolyte solution on the surface of the positive electrode active material when the voltage of a positive electrode is higher than 4.4 V on a lithium basis.

### Solution to Problem

A non-aqueous electrolyte secondary battery according to one aspect of the present invention includes a positive electrode having a positive electrode active material that intercalates and deintercalates lithium ions, a negative electrode having a negative electrode active material that intercalates and deintercalates lithium ions, and a non-aqueous electrolyte. The positive electrode active material includes a lithium-cobalt composite oxide containing nickel, manganese, aluminum, and germanium. The percentage of cobalt in the lithium-cobalt composite oxide is 80 mol % or more with respect the total molar amount of metal elements except lithium.

### Advantageous Effects of Invention

According to a non-aqueous electrolyte secondary battery in one aspect of the present invention, there is provided a long-life non-aqueous electrolyte secondary battery in which the structural change of a positive electrode active material and the reaction between the positive electrode active material and an electrolyte solution on the surface of the active material are eliminated or reduced even when the charge voltage is 4.6 V, which is very high, on a lithium basis.

### BRIEF DESCRIPTION OF DRAWINGS

FIG. 1 illustrates a SEM image of a positive electrode active material having a rare earth compound attached to the surface.

FIG. 2 is a perspective view of a laminate-type non-aqueous electrolyte secondary battery in an embodiment.

FIG. 3 is a perspective view of a wound electrode body in FIG. 2.

### DESCRIPTION OF EMBODIMENTS

Embodiments of the present invention will be described below. The embodiments are examples of practice of the present invention, and the present invention is not limited to the embodiments.

[Non-Aqueous Electrolyte Secondary Battery]

An example non-aqueous electrolyte secondary battery according to an embodiment of the present invention includes a positive electrode, a negative electrode, and a non-aqueous electrolyte. A non-aqueous electrolyte secondary battery, which is an example of this embodiment, has a structure in which, for example, a battery outer can accommodates a non-aqueous electrolyte solution, which is a liquid non-aqueous electrolyte, and an electrode body formed by winding or layering a positive electrode and a negative electrode with a separator therebetween. The non-aqueous electrolyte secondary battery is not limited to this structure. Each component of the non-aqueous electrolyte secondary battery will be described below in detail.

[Positive Electrode]

The positive electrode preferably includes a positive-electrode current collector and a positive-electrode mixture layer formed on the positive-electrode current collector. Examples of the positive-electrode current collector include a conductive thin film body, a metal foil or alloy foil stable in the potential range of the positive electrode, particularly an aluminum foil or the like, and a film having a metal surface layer, such as that formed of aluminum. The positive-electrode mixture layer preferably contains a binding agent and a conductive agent in addition to positive electrode active material particles.

The positive electrode active material is a lithium-cobalt composite oxide containing nickel, manganese, aluminum, and germanium. The percentage of cobalt in the lithium-cobalt composite oxide is 80 mol % or more with respect the total molar amount of metal elements except lithium.

The use of the lithium-cobalt composite oxide eliminates or reduces the phase transition from the O3 structure to the H1-3 structure, for example, even when the battery is charged to 4.53 V or more on a lithium basis. This stabilizes the crystal structure of the positive electrode and improves cycle performance.

The composition formula of the lithium-cobalt composite oxide is preferably represented by LiCoₓNi_{y}Mn_{z}AlᵥGe_{w}O₂ (0.8≦x<1, 0.05≦y≦0.15, 0.01≦z≦0.1, 0.005≦v≦0.02, and 0.005≦w≦0.02). Since the crystal structure of the lithium-cobalt composite oxide having such a composition is particularly stable, the crystal structure of the positive electrode active material is unlikely to undergo phase transition, for example, even when the battery is charged to 4.53 V or more on a lithium basis.

A rare earth compound is preferably attached to part of the surface of the lithium-cobalt composite oxide. Examples of the rare earth compound include rare earth hydroxides, oxyhydroxides, oxides, carbonate compounds, phosphate compounds, and fluorine compounds. Of these, at least one compound selected from rare earth hydroxides and oxyhydroxides is particularly preferred.

Examples of rare earth elements in the rare earth compound include scandium, yttrium, lanthanum, cerium, praseodymium, neodymium, samarium, europium, gadolinium, terbium, dysprosium, holmium, erbium, thulium, ytterbium, and lutetium. Of these, neodymium, samarium, and erbium are preferred, and erbium is particularly preferred.

Specific examples of rare earth compounds include hydroxides and oxyhydroxides, such as neodymium hydroxide, neodymium oxyhydroxide, samarium hydroxide, samarium oxyhydroxide, erbium hydroxide, and erbium oxyhydroxide; phosphate compounds and carbonate compounds, such as neodymium phosphate, samarium phosphate, erbium phosphate, neodymium carbonate, samarium carbonate, and erbium carbonate; and oxides and fluorine compounds, such as neodymium oxide, samarium oxide, erbium oxide, neodymium fluoride, samarium fluoride, and erbium fluoride.

A mixture of the aforementioned positive electrode active material and other positive electrode active materials may be used as a positive electrode active material.

Examples of the binding agent include fluorine-containing polymers and rubber-based polymers. Examples of fluorine-containing polymers include polytetrafluoroethylene (PTFE), polyvinylidene fluoride (PVdF), and modified products thereof. Examples of rubber-based polymers include an ethylene-propylene-isoprene copolymer and an ethylene-propylene-butadiene copolymer. These may be used alone or in combination of two or more. The binding agent may be used together with a thickener, such as carboxylmethyl cellulose (CMC) or polyethylene oxide (PEO). Examples of the conductive agent include carbon materials, such as carbon black, acetylene black, Ketjenblack, and graphite. These may be used alone or in combination of two or more.

[Negative Electrode]

The negative electrode is obtained by, for example, mixing a negative electrode active material and a binding agent with water or a suitable solvent, and applying the mixture to a negative-electrode current collector, followed by drying and rolling. The negative-electrode current collector is preferably a conductive thin film body, a metal foil or alloy foil stable in the potential range of the negative electrode, particularly a copper foil or the like, or a film having a metal surface layer, such as that formed of copper. The binding agent may be PTFE or the like as in the case of the positive electrode, and preferably a styrene-butadiene copolymer (SBR) or a modified product thereof or the like. The binding agent may be used together with a thickener, such as CMC.

The negative electrode active material is any material that reversibly intercalates and deintercalates lithium ions. Examples of the negative electrode active material include carbon materials, metals and alloy materials, such as Si and Sn, to be alloyed with lithium, and metal oxides. These may be used alone or in a mixture of two or more. Negative electrode active materials selected from carbon materials, metals and alloy materials to be alloyed with lithium, and metal oxides may be used in combination.

[Non-Aqueous Electrolyte]

Examples of the solvent that can be used in the non-aqueous electrolyte include cyclic carbonates, such as ethylene carbonate, propylene carbonate, butylene carbonate, and vinylene carbonate; fluorinated cyclic carbonates; chain carbonates, such as dimethyl carbonate, methyl ethyl carbonate, and diethyl carbonate; fluorinated chain carbonates; and chain carboxylates and fluorinated chain carboxylates. In particular, a mixed solvent of a cyclic carbonate and a chain carbonate or a chain carboxylate is preferably used as a non-aqueous solvent having high lithium-ion conductivity from the viewpoint of high permittivity, low viscosity, and low melting point. The volume ratio of the cyclic carbonate to the chain carbonate or chain carboxylate in the mixed solvent is preferably controlled in the range of 2:8 to 5:5.

Fluorinated solvents, such as fluorinated cyclic carbonates, fluorinated chain carbonates, and fluorinated chain carboxylates, are preferred because they have a high oxidation decomposition potential and high oxidation resistance and are thus less likely to be decomposed during high-voltage charge storage. Examples of fluorinated cyclic carbonates include fluoroethylene carbonate (FEC), 4,5-difluoroethylene carbonate, 4,4-difluoroethylene carbonate, 4,4,5-trifluoroethylene carbonate, and 4,4,5,5-tetrafluoroethylene carbonate. Of these, fluoroethylene carbonate is particularly preferred. Examples of fluorinated chain carbonates include fluorinated methyl ethyl carbonate. Examples of fluorinated chain carboxylates include fluorinated methyl propionate.

These solvents can be used together with esters, such as methyl acetate, ethyl acetate, propyl acetate, methyl propionate, ethyl propionate, and γ-butyrolactone; sulfone group-containing compounds, such as propanesultone; ethers, such as 1,2-dimethoxyethane, 1,2-diethoxyethane, tetrahydrofuran, 1,3-dioxane, 1,4-dioxane, and 2-methyltetrahydrofuran; nitriles, such as butyronitrile, valeronitrile, n-heptanenitrile, succinonitrile, glutaronitrile, adiponitrile, pimelonitrile, 1,2,3-propanetricarbonitrile, 1,3,5-pentanetricarbonitrile, and hexamethylene diisocyanate; and amides, such as dimethylformamide. Solvents obtained by substituting part of hydrogen atoms H in these solvents with fluorine atoms F may be used. 1,3-Propanesultone and hexamethylene diisocyanate are particularly preferred in order to form an appropriate coating film on the surface of the positive electrode or the surface of the negative electrode.

Examples of the solute that can used in the non-aqueous electrolyte include fluorine-containing lithium salts, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, and LiAsF₆. Furthermore, a lithium salt [a lithium salt (e.g., LiClO₄) containing at least one element selected from P, B, O, S, N, and Cl] other than fluorine-containing lithium salts may be added to a fluorine-containing lithium salt and used. In particular, the non-aqueous electrolyte preferably contains a fluorine-containing lithium salt and a lithium salt having an oxalate complex as an anion in order to form a stable coating film on the surface of the negative electrode in a high-temperature environment.

Examples of the lithium salt having an oxalate complex as an anion include LiBOB [lithium bis(oxalate)borate], Li[B(C₂O₄)F₂], Li[P(C₂O₄)F₄], and Li[P(C₂O₄)₂F₂]. Of these, LiBOB, which forms a stable coating film on the negative electrode, is preferably used. The above solutes may be used alone or in a mixture of two or more.

[Separator]

For example, a polypropylene separator or a polyethylene separator, a polypropylene-polyethylene multilayer separator, or a separator having the surface coated with a resin, such as an aramid resin, may be used as a separator.

### Experimental Example 1-1

[Production of Positive Electrode]

Lithium carbonate was used as a source of lithium. Cobalt tetroxide was used as a source of cobalt. Nickel hydroxide, manganese dioxide, aluminum hydroxide, and germanium dioxide were used as sources of nickel, manganese, aluminum, and germanium, which were elements for substituting cobalt. Cobalt tetroxide, nickel hydroxide, manganese dioxide, aluminum hydroxide, and germanium dioxide were dry-mixed such that the molar ratio of cobalt, nickel, manganese, aluminum, and germanium was 90:5:5:1:1. This mixture was mixed with lithium carbonate such that the molar ratio of lithium and transition metals was 1:1. The powder was formed into a pellet, which was then fired at 900° C. for 24 hours in an air atmosphere to provide a positive electrode active material.

A mixture of 96.5 parts by mass of the positive electrode active material, 1.5 parts by mass of acetylene black as a conductive agent, and 2.0 parts by mass of a polyvinylidene fluoride powder as a binding agent was mixed with an N-methylpyrrolidone solution to provide a positive-electrode mixture slurry. Next, the positive-electrode mixture slurry was applied by a doctor blade method to both sides of an aluminum foil having a thickness of 15 μm, which was a positive-electrode current collector, and as a result, positive-electrode active-material-mixture layers were formed on both sides of the positive-electrode current collector. The positive-electrode active-material-mixture layers were dried and then roiled with a compression roller, followed by cutting into a predetermined size to provide a positive electrode plate. A portion of the positive electrode plate on which no positive-electrode active-materiai-mixture layer was formed was fitted with an aluminum tab, which was a positive-electrode current-collecting tab, to provide a positive electrode. The amount of the positive-electrode active-material-mixture layers was 39 mg/cm², and the thickness of the positive-electrode mixture layer was 120 μm.

[Production of Negative Electrode Plate]

Graphite, carboxymethyl cellulose as a thickener, and a styrene butadiene rubber as a binding material were weighted such that the mass ratio was 98:1:1 and dispersed in water to provide a positive-electrode active-material-mixture slurry. The positive-electrode active-material-mixture slurry was applied by a doctor blade method to both sides of a negative-electrode core body, which was made of copper and had a thickness of 8 μm. The slurry was then dried at 110° C. to remove water and, as a result, negative-electrode active-material layers were formed. The negative-electrode active-material layers were then rolled into a predetermined thickness with a compression roller, followed by cutting into a predetermined size to provide a negative electrode plate.

[Preparation of Non-aqueous Electrolyte Solution]

Fluoroethylene carbonate (FEC) and fluorinated propione carbonate (FMP) were provided as non-aqueous solvents. These solvents were mixed such that the volume ratio of FEC to FMP at 25° C. was 20:80. In this non-aqueous solvent mixture, 1 mol/L of lithium hexafluorophosphate was dissolved to provide a non-aqueous electrolyte.

[Production of Non-aqueous Electrolyte Secondary Battery]

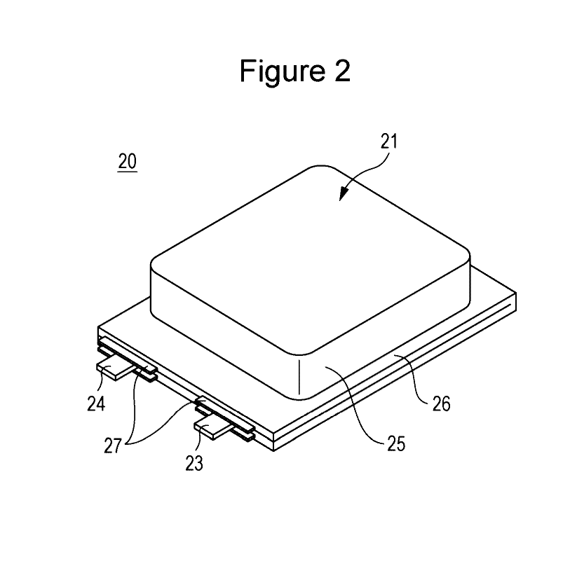

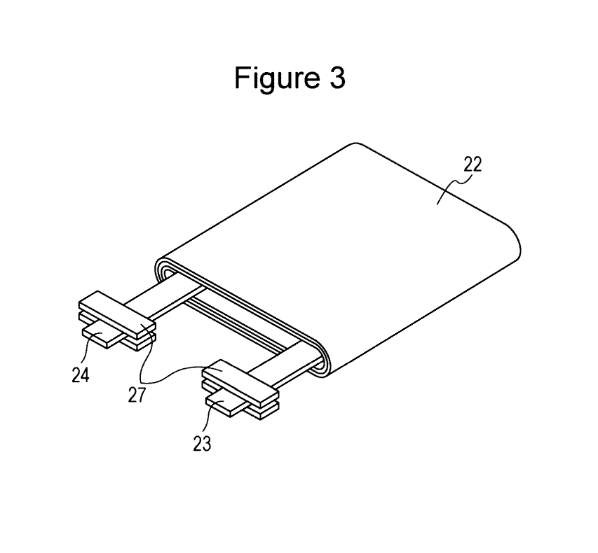

The evaluation of the properties of a non-aqueous electrolyte secondary battery will be described. First, a method for producing a non-aqueous electrolyte secondary battery will be described with reference to FIG. 2 and FIG. 3. A laminate-type non-aqueous electrolyte secondary battery 20 includes a laminate outer body 21, a wound electrode body 22 including a positive electrode plate and a negative electrode plate and having a flat shape, a positive electrode current-collecting tab 23 connected to the positive electrode plate, and a negative-electrode current-collecting tab 24 connected to the negative electrode plate. The wound electrode body 22 has the positive electrode plate, the negative electrode plate, and a separator, all of which have a strip shape. The positive electrode plate and the negative electrode plate are wound while being insulated from each other with the separator therebetween.

The laminate outer body 21 has a recess 25. One end side of the laminate outer body 21 is folded so as to cover the opening of the recess 25. An end portion 26 around the recess 25 is welded together with the folded portion that faces the end portion 26, and this welding seals the laminate outer body 21. The sealed laminate outer body 21 accommodates the wound electrode body 22 and a non-aqueous electrolyte solution.

The positive-electrode current-collecting tab 23 and the negative-electrode current-collecting tab 24 are disposed so as to project from the sealed laminate outer body 21 through resin members 27. This configuration allows electric power to be supplied to the outside through the positive-electrode current-collecting tab 23 and the negative-electrode current-collecting tab 24. Each resin member 27 is disposed between the laminate outer body 21 and each of the positive-electrode current-collecting tab 23 and the negative-electrode current-collecting tab 24 for the purpose of improving adhesiveness and avoiding a short circuit through an aluminum alloy layer in a laminate material.

The positive electrode plate and negative electrode plate thus produced were wound with a separator therebetween. The separator was a polyethylene microporous film. A polypropylene tape was adhered to the outermost surface to provide a cylindrical wound electrode body. Next, this electrode body was pressed into a fiat wound electrode body. A sheet-shaped laminate material having a five-layer structure including a polypropylene resin layer/adhesive layer/aluminum-alloy layer/adhesive layer/polypropylene resin layer was prepared. This laminate material was folded to form a bottom and to form a cup-shaped electrode-body storage space.

Next, the flat wound electrode body and the non-aqueous electrolyte were inserted into the cup-shaped electrode-body storage space in a glovebox with an argon atmosphere. Subsequently, the laminate outer body was evacuated so that the separator was impregnated with the non-aqueous electrolyte, and the opening of the laminate outer body was sealed. This process yielded a non-aqueous electrolyte secondary battery 62 mm in height, 35 mm in width, and 3.6 mm in thickness (size excluding the sealed portion). The theoretical capacity of this battery was 800 mAh when the charge voltage was 4.5 V on a lithium basis.

### Experimental Example 1-2

A non-aqueous electrolyte secondary battery was produced in the same manner as in Experimental Example 1-1 except that a positive electrode active material was prepared such that the molar ratio of cobalt, nickel, manganese, and aluminum was 90:5:5:1.

### Experimental Example 1-3

A non-aqueous electrolyte secondary battery was produced in the same manner as in Experimental Example 1-1 except that a positive electrode active material was prepared such that the molar ratio of cobalt, nickel, manganese, and germanium was 90:5:5:1.

### Experimental Example 1-4

A non-aqueous electrolyte secondary battery was produced in the same manner as in Experimental Example 1-1 except that, a positive electrode active material was prepared such that the molar ratio of cobalt and nickel was 90:10.

[Conditions of Charge/Discharge Cycle]

The charge/discharge test was conducted on the batteries under the following conditions.

Each battery was charged to a voltage of 4.50 V at a constant current of 400 mA. After the battery voltage reached this value, the battery was charged at this constant voltage until the current reached 40 mA. The battery was then discharged to a voltage of 2.50 V at a constant current of 800 mA. The quantity of electricity that flowed at this time was measured, and the first discharge capacity was calculated. The measurement temperature was 45° C. The potential of the graphite used in a negative electrode was about 0.1 V on a lithium basis. Because of this, the positive electrode potential was about from 4.53 V to 4.60 V on a lithium basis when the battery voltage was 4.50 V. Charging and discharging were repeated under the same conditions as described above. The 100th discharge capacity was measured, and the capacity retention was calculated in accordance with the following equation.

Capacity retention (%)=(100th discharge capacity/first discharge capacity)×100

The relative value of the capacity retention of each battery is shown in Table 1 given that the capacity retention of the battery used in Experimental Example 1-4 is 100.

TABLE 1

| | Substitution element | | | | | |
|---|---|---|---|---|---|---|
| | Co | Ni | Mn | Al | Ge | |
| | mol | mol | mol | mol | mol | Capacity |
| | % | % | % | % | % | retention |
| Experimental | 90 | 5 | 5 | 1 | 1 | 146 |
| example 1-1 | | | | | | |
| Experimental | 90 | 5 | 5 | 1 | | 127 |
| example 1-2 | | | | | | |
| Experimental | 90 | 5 | 5 | | 1 | 112 |
| example 1-3 | | | | | | |
| Experimental | 90 | 10 | 0 | | | 100 |
| example 1-4 | | | | | | |

The cycle performance of the battery according to Experimental Example 1-4 where substitution elements were only cobalt and nickel was lower than that of the battery according to Experimental Example 1-1 where the lithium-cobalt composite oxide contained cobalt, nickel, manganese, aluminum, and germanium. This is probably because the presence of both aluminum and germanium in the lithium-cobalt composite oxide stabilized the internal structure and the surface structure of the active material and accordingly eliminated or reduced decomposition of the electrolyte solution, which suppressed degradation in cycle performance.

The cycle performance of the batteries according to Experimental Examples 1-2 and 1-3 where the lithium-cobalt composite oxide contained either aluminum or germanium in addition to cobalt, nickel, and manganese were lower than that of the battery according to Experimental Example 1-1 where the lithium-cobalt composite oxide contained cobalt, nickel, manganese, aluminum, and germanium. These results probably indicate that aluminum stabilized the internal structure, but the surface of the positive electrode active material became active and reacted with the electrolyte solution in order to suppress a reduction in OCV during charging, which degraded cycle performance. The results probably indicate that germanium stabilized the surface structure, but the collapse of the internal structure proceeded, which degraded cycle performance. Therefore, the presence of both aluminum and germanium in the lithium-cobalt composite oxide is supposed to stabilize the structure of the active material and accordingly suppress degradation in cycle performance.

### Experimental Example 2-1

[Production of Positive Electrode]

A positive electrode active material was prepared such that the molar ratio of cobalt, nickel, manganese, aluminum, and germanium was 90:5:5:0.5:0.5.

Next, a rare earth compound was attached to the surface of the positive electrode active material by a wet method as described below. A mixture of 1000 g of the positive electrode active material and 3 L of pure water was stirred to provide a suspension in which the positive electrode active material was dispersed. While an aqueous solution of sodium hydroxide was added to the suspension so as to maintain the suspension at pH 9, a solution in which 1.85 g of erbium nitrate pentahydrate was dissolved as a source of the rare earth compound was added to the suspension.

When the pH of the suspension is smaller than 9, erbium hydroxide and erbium oxyhydroxide are unlikely to precipitate. When the pH of the suspension is larger than 9, these substances precipitate at a high reaction rate, and the substances are unevenly dispersed on the surface of the positive electrode active material.

Next, the suspension was suction-filtered, and the residue was further washed with water to provide powder. The powder was heated at 120° C. This process yielded a positive-electrode active-material powder in which erbium hydroxide was uniformly attached to the surface of the positive electrode active material.

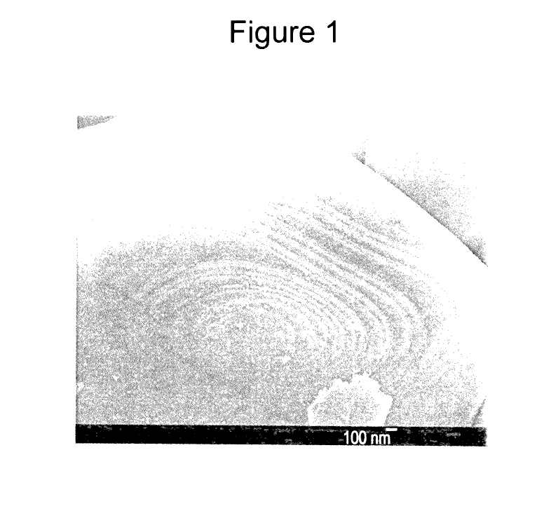

FIG. 1 illustrates a SEM image of the positive electrode active material having the rare earth compound on the surface. It has been confirmed that an erbium compound was uniformly dispersed on and attached to the surface of the positive electrode active material. The erbium compound had an average particle size of 100 nm or less. As measured by using high-frequency inductively coupled plasma emission spectroscopy, the amount of the erbium compound attached was 0.07 parts by mass on an erbium element basis with respect to the positive electrode active material.

When the microparticles of a rare earth element compound are dispersedly attached to the surface of the positive electrode active material, the structural change of the positive electrode active material can be eliminated or reduced during the charge/discharge reactions at high potential. The reason for this is unclear but is probably that attachment of the hydroxide of a rare earth element to the surface increases the reaction overpotentiai during charging and can reduce a change in crystal structure due to phase transition.

A non-aqueous electrolyte secondary battery was produced in the same manner as in Experimental Example 1-1 by using the positive electrode active material having the rare earth compound on the surface and prepared as described above.

### Experimental Example 2-2

A non-aqueous electrolyte secondary battery was produced in the same manner as in Experimental Example 2-1 except that a positive electrode active material was prepared such that the molar ratio of cobalt, nickel, manganese, aluminum, and germanium was 90:5:5:1:1.

### Experimental Example 2-3

A non-aqueous electrolyte secondary battery was produced in the same manner as in Experimental Example 2-1 except that a positive electrode active material was prepared such that the molar ratio of cobalt, nickel, and manganese was 90:5:5.

### Experimental Example 2-4

A non-aqueous electrolyte secondary battery was produced in the same manner as in Experimental Example 2-1 except that, a positive electrode active material was prepared such that the molar ratio of cobalt and manganese was 90:10.

### Experimental Example 2-5

A non-aqueous electrolyte secondary battery was produced in the same manner as in Experimental Example 2-1 except that a positive electrode active material was prepared such that the molar ratio of cobalt, nickel, and manganese was 90:1:9.

### Experimental Example 2-6

A non-aqueous electrolyte secondary battery was produced in the same manner as in Experimental Example 2-1 except that a positive electrode active material was prepared such that the molar ratio of cobalt, nickel, and manganese was 90:3:7.

### Experimental Example 2-7

A non-aqueous electrolyte secondary battery was produced in the same manner as in Experimental Example 2-1 except that a positive electrode active material was prepared such that the molar ratio of cobalt, nickel, and manganese was 90:7:3.

### Experimental Example 2-8

A non-aqueous electrolyte secondary battery was produced in the same manner as in Experimental Example 2-1 except that a positive electrode active material was prepared such that the molar ratio of cobalt, nickel, and manganese was 90:9:1.

### Experimental Example 2-9

A non-aqueous electrolyte secondary battery was produced in the same manner as in Experimental Example 2-1 except that a positive electrode active material was prepared such that the molar ratio of cobalt and nickel was 90:10.

### Experimental Example 2-10

A non-aqueous electrolyte secondary battery was produced in the same manner as in Experimental Example 2-1 except that a positive electrode active material was prepared such that the molar ratio of cobalt, nickel, manganese, and aluminum was 90:5:5:0.05.

### Experimental Example 2-11

A non-aqueous electrolyte secondary battery was produced in the same manner as in Experimental Example 2-1 except that a positive electrode active material was prepared such that the molar ratio of cobalt, nickel, manganese, and aluminum was 90:5:5:1.

### Experimental Example 2-12

A non-aqueous electrolyte secondary battery was produced in the same manner as in Experimental Example 2-1 except that a positive electrode active material was prepared such that the molar ratio of cobalt, nickel, manganese, and aluminum was 90:5:5:2.

### Experimental Example 2-13

A non-aqueous electrolyte secondary battery was produced in the same manner as in Experimental Example 2-1 except that a positive electrode active material was prepared such that the molar ratio of cobalt, nickel, manganese, and germanium was 90:5:5:1.

### Experimental Example 2-14

A non-aqueous electrolyte secondary battery was produced in the same manner as in Experimental Example 2-1 except that a positive electrode active material was prepared such that the molar ratio of cobalt, nickel, manganese, and germanium was 90:5:5:2.

### Experimental Example 2-15

A non-aqueous electrolyte secondary battery was produced in the same manner as in Experimental Example 2-1 except that a positive electrode active material was prepared such that the molar ratio of cobalt, nickel, manganese, and germanium was 90:5:5:3.

[Conditions of Charge/Discharge Cycle]

The charge/discharge test was conducted on the batteries according to Experimental Examples 2-1 to 2-15 under the same conditions as those for the batteries according to Experimental Examples 1-1 to 1-4.

The relative value of the capacity retention of each battery is shown in Table 2 given that the capacity retention of the battery used in Experimental Example 1-4 is 100.

TABLE 2

| | Substitution element | | | | | |
|---|---|---|---|---|---|---|
| | Co | Ni | Mn | Al | Ge | |
| | mol | mol | mol | mol | mol | Capacity |
| | % | % | % | % | % | retention |
| Experimental | 90 | 5 | 5 | 0.5 | 0.5 | 201 |
| example 2-1 | | | | | | |
| Experimental | 90 | 5 | 5 | 1 | 1 | 215 |
| example 2-2 | | | | | | |
| Experimental | 90 | 5 | 5 | | | 193 |
| example 2-3 | | | | | | |
| Experimental | 90 | 0 | 10 | | | 126 |
| example 2-4 | | | | | | |
| Experimental | 90 | 1 | 9 | | | 128 |
| example 2-5 | | | | | | |
| Experimental | 90 | 3 | 7 | | | 145 |
| example 2-6 | | | | | | |
| Experimental | 90 | 7 | 3 | | | 165 |
| example 2-7 | | | | | | |
| Experimental | 90 | 9 | 1 | | | 158 |
| example 2-8 | | | | | | |
| Experimental | 90 | 10 | 0 | | | 147 |
| example 2-9 | | | | | | |
| Experimental | 90 | 5 | 5 | 0.05 | | 134 |
| example 2-10 | | | | | | |
| Experimental | 90 | 5 | 5 | 1 | | 186 |
| example 2-11 | | | | | | |
| Experimental | 90 | 5 | 5 | 2 | | 190 |
| example 2-12 | | | | | | |
| Experimental | 90 | 5 | 5 | | 1 | 165 |
| example 2-13 | | | | | | |
| Experimental | 90 | 5 | 5 | | 2 | 195 |
| example 2-14 | | | | | | |
| Experimental | 90 | 5 | 5 | | 3 | 190 |
| example 2-15 | | | | | | |

The cycle performance of the batteries according to Experimental Examples 2-3 to 2-9 where the lithium-cobalt composite oxide contained no aluminum or germanium was lower than that of the batteries according to Experimental Examples 2-1 and 2-2 where the lithium-cobalt composite oxide contained cobalt, nickel, manganese, aluminum, and germanium.

The comparison among Experimental Examples 2-3 to 2-9 indicates that the battery according to Experimental Example 2-3 where substitution was performed with nickel and manganese at the same percentage had the highest capacity retention. In Experimental Example 2-3, nickel has a valence of 2, and manganese has a valence of 4. In Comparative Examples 2 to 7, part of nickel and manganese have a valance of 3. Since Ni³⁺ and Mn³⁺ distort the crystal because of the Jahn-Teller effect, the presence of these elements in the positive electrode active material is supposed to make the structure unstable and thus degrade cycle performance.

The cycle performance of the batteries according to Experimental Examples 2-10 to 2-15 where the lithium-cobalt composite oxide contained either aluminum or germanium in addition to cobalt, nickel, and manganese was lower than that of the batteries according to Experimental Examples 2-1 and 2-2 where the lithium-cobalt composite oxide contained cobalt, nickel, manganese, aluminum, and germanium.

The influence of attachment of the rare earth compound to the surface of the positive electrode active material was studied based on Tables 1 and 2. A difference in capacity retention after 100 cycles between Experimental Example 1-1 and Experimental Example 2-2 is largest among differences between Experimental Example 1-1 and Experimental Example 2-2, between Experimental Example 1-2 and Experimental Example 2-11, between Experimental Example 1-3 and Experimental Example 2-13, and between Experimental Example 1-4 and Experimental Example 2-9. That is, the effect of improving cycle performance when the rare earth compound is attached to the positive electrode active material that contains cobalt, nickel, manganese, aluminum, and germanium is larger than that when the rare earth compound is attached to the positive electrode active material that does not contain all of cobalt, nickel, manganese, aluminum, and germanium. This is probably because the rare earth compound increases the reaction overpotentiai on the surface of the positive electrode active material, and a change in crystal structure due to phase transition decreases.

Although examples of laminate-type non-aqueous electrolyte secondary batteries are described above in Experimental Examples, the present invention is not limited to these and can be applied to cylindrical non-aqueous electrolyte secondary batteries and prismatic non-aqueous electrolyte secondary batteries having a metal outer can.

### INDUSTRIAL APPLICABILITY

A non-aqueous electrolyte secondary battery according to one aspect of the present invention can be used in applications that particularly require a high capacity and a long life, such as mobile phones, laptop computers, smart phones, and tablet terminals.

### REFERENCE SIGNS LIST

20. Non-aqueous electrolyte secondary battery, 21. Laminate outer body, 22. Wound electrode body, 23. Positive-electrode current-collecting tab, 24. Negative-electrode current-collecting tab

1. A non-aqueous electrolyte secondary battery comprising: a positive electrode having a positive electrode active material that intercalates and deintercalates lithium ions; a negative electrode having a negative electrode active material that intercalates and deintercalates lithium ions; and a non-aqueous electrolyte,
wherein the positive electrode active material includes a lithium-cobalt composite oxide containing nickel, manganese, aluminum, and germanium, and a percentage of cobalt in the lithium-cobalt composite oxide is 80 mol % or more with respect a total molar amount of metal elements except lithium.

2. The non-aqueous electrolyte secondary battery according to claim 1, wherein the lithium-cobalt composite oxide is represented by LiCoₓNi_{y}Mn_{z}AlᵥGe_{w}O₂ (0.8≦x<1, 0.05≦y≦0.15, 0.01 ≦z≦0.1, 0.005≦v≦0.02, and 0.005≦w≦0.02).

3. The non-aqueous electrolyte secondary battery according to claim 1, wherein a rare earth compound is attached to part of a surface of the lithium-cobalt composite oxide.

4. The non-aqueous electrolyte secondary battery according to claim 3, wherein the rare earth compound contains at least one of hydroxides and oxyhydroxides.

5. The non-aqueous electrolyte secondary battery according to claim 1, wherein the battery is charged such that a potential of the positive electrode is 4.6 V on a lithium basis.

6. The non-aqueous electrolyte secondary battery according to claim 1, wherein the non-aqueous electrolyte contains a fluorinated solvent.

7. The non-aqueous electrolyte secondary battery according to claim 6, wherein the fluorinated solvent contains any of fluoroethylene carbonate, fluorinated methyl propionate, and fluorinated methyl ethyl carbonate.
